(19) United States
(12) Patent Application Publication
(10) Pub. No.: US 2025/0046327 A1
(43) Pub. Date: Feb. 6, 2025

(54) SOURCE SEPARATION APPARATUS, SOURCE SEPARATION METHOD, AND PROGRAM

(71) Applicant: NIPPON TELEGRAPH AND TELEPHONE CORPORATION, Tokyo (JP)

(72) Inventors: Hiroshi SAWADA, Tokyo (JP); Rintaro IKESHITA, Tokyo (JP); Keisuke KINOSHITA, Tokyo (JP); Tomohiro NAKATANI, Tokyo (JP)

(21) Appl. No.: 18/716,283

(22) PCT Filed: Dec. 6, 2021
(86) PCT No.: PCT/JP2021/044772

§ 371 Date: Jun. 4, 2024

(51) Int. Cl. G10L 21/0272

(52) U.S. Cl. CPC G10L 21/0272

(57) ABSTRACT

A source separation apparatus includes circuitry configured to create a second observation signal vector by using (i) a first observation signal vector representing an observation signal that is obtained by mixing target signals from a plurality of signal sources and (ii) a time delay set in which a time delay until a part of the target signals is observed is used as an element, the second observation signal vector being obtained by extending the first observation signal vector in consideration of the time delay; optimize, by using a predetermined algorithm, a parameter for a correlation matrix representing a transmission characteristic in consideration of the time delay for the target signals, and power of a given signal source at each time; and separate the target signals by using an optimized parameter and the second observation signal vector.

### TECHNICAL FIELD

The present invention relates to a source separation apparatus, a source separation method, and a program.

### BACKGROUND ART

As one of methods belonging to the field of signal processing, a method called blind source separation (BSS) is known. Blind signal separation is a method of separating a target source signal from mixed signals observed by a plurality of sensors in a situation where there is no information on how source signals are mixed.

As blind signal separation that can be separated even with a larger number N of signal sources than the number M of sensors, a method called full-rank spatial covariance analysis (FCA) is known (Non Patent Literature 1).

Meanwhile, in a case where a sound signal is considered as a signal, in general, in a space such as a room, sound is reflected by a wall or the like, and reverberation occurs. In FCA, it is known that the separation performance may decrease as the reverberation time increases. This is partly because the main part of the reverberation does not fall within a time frame length when the sound signal of a time waveform is converted into a frequency waveform by short-time Fourier transform (STFT).

Meanwhile, a method called FCA with delayed source components (hereinafter, this is also referred to as FCAd) is known as a method for dealing with the reverberation by considering a time-delayed sound source component (Non Patent Literature 2).

### CITATION LIST

### Non Patent Literature

Non Patent Literature 1: N. Q. K. Duong, E. Vincent, and R. Gribonval, “Underdetermined reverberant audio source separation using a fullrank spatial covariance model,” IEEE Trans. Audio, Speech, and Language Processing, vol. 18, no. 7, pp. 1830-1840-9-2010.
Non Patent Literature 2: M. Togami, “Multi-channel speech source separation and dereverberation with sequential integration of determined and underdetermined models,” in Proc. ICASSP, 2020, pp. 231-235.

### SUMMARY OF INVENTION

### Technical Problem

However, it has been difficult to achieve sufficient separation performance by a conventional method such as FCA or FCAd. In particular, when the reverberation time is long, in the conventional method, the separation performance may deteriorate as the number of repetitions of an algorithm for parameter update (for example, an expectation maximization (EM) algorithm or the like) increases.

An embodiment of the present invention has been made in view of the above points, and an object thereof is to accurately separate a source signal from an observation signal even when a source component has a time delay.

### Solution to Problem

In order to achieve the above object, a source separation apparatus according to an embodiment includes a creation unit configured to create, by using a first observation signal vector representing an observation signal obtained by mixing target signals from a plurality of signal sources and a time delay set having a time delay until a part of the target signals is observed as an element, a second observation signal vector obtained by extending the first observation signal vector in consideration of the time delay, an optimization unit configured to optimize, by a predetermined algorithm, a parameter including a correlation matrix representing a transmission characteristic in consideration of the time delay of the target signals and power of the signal source at each time, and a separation unit configured to separate the target signals by using the parameter after optimization and the second observation signal vector.

### Advantageous Effects of Invention

Even when there is a time delay in the source component, the source signal can be accurately separated from the observation signal.

### BRIEF DESCRIPTION OF DRAWINGS

FIG. 1 is a diagram illustrating an example of an observation signal vector influenced by a sound source component.

FIG. 2 is a diagram illustrating a calculation example of a Ili operator.

FIG. 3 is a diagram illustrating a calculation example of a BoffDiag operator.

FIG. 4 is a diagram illustrating an example of a hardware configuration of a signal separation device according to the present embodiment.

FIG. 5 is a diagram illustrating an example of a functional configuration of the signal separation device according to the present embodiment.

FIG. 6 is a diagram illustrating an example of a detailed functional configuration of an EM algorithm unit according to the present embodiment.

FIG. 7 is a flowchart illustrating a flow of an example of signal separation processing according to the present embodiment.

FIG. 8 is a flowchart illustrating a flow of an example of an EM algorithm according to the present embodiment.

FIG. 9 is a diagram illustrating an experiment setting.

FIG. 10 is a diagram illustrating evaluation results (part 1).

FIG. 11 is a diagram illustrating evaluation results (part 2).

### DESCRIPTION OF EMBODIMENTS

Hereinafter, an embodiment of the present invention will be described. In the present embodiment, for a sound signal, a signal separation device 10 capable of accurately separating a source signal from an observation signal even when there is a time delay in a sound source component due to reverberation or the like will be described. However, targeting a sound signal is an example, and it is possible to target any type of signal that may cause a time delay in the observation of the source component.

### <FCA>

FCA, which is one of conventional methods, will be described below. Note that, for details of FCA, refer to Non Patent Literature 1 and the like.

### <<Model and Objective Function>>

Let N>M, and let n=1, . . . , N for the sound source and m=1, . . . , M for the sensor. In addition, a time frame when a sound signal of a time waveform is converted into a frequency waveform by STFT is denoted by t∈{1, . . . , T}, and a frequency bin is denoted by f∈{1, . . . , F}, an observation signal of a frequency bin f observed by M sensors in a time frame t is represented by an M-dimensional vector x_{tf}=[X_{1tf}, . . . , x_{Mtf}]^{T}∈C^{M}, and is referred to as an observation signal vector.

At this time, it is assumed that each observation signal vector x_{tf} is represented by a sum of N sound source components c_{ntf}∈C_{M}. That is, it is assumed to be expressed as follows.

$$\\ \begin{matrix}[ Math . 1 ] & \\ {x}_{tf} = {\sum }_{n = 1}^{N} {c}_{ntf} & ( 1 )\end{matrix}$$

Furthermore, each sound source component c_{ntf} follows the following multivariate Gaussian distribution with an average vector of zero and a covariance matrix of c_{ntf}.

$$\\ \begin{matrix}[ Math . 2 ] & \\ p ( {c}_{ntf} ) = 𝒩 ( {c}_{ntf} \vert 0 , {C}_{ntf} ) & \end{matrix}$$

### Here,

$$\\ \begin{matrix}[ Math . 3 ] & \\ {C}_{ntf} = {s}_{ntf} {A}_{nf} & ( 2 )\end{matrix}$$

is defined. A_{nf} is a spatial correlation matrix representing a transmission characteristic (invariant to the time frame t) from a sound source n to the M sensors, and s_{ntf} is the power of the sound source n in the time frame t and the frequency bin f.

The objective function to be maximized is the sum of the following log likelihoods.

$$\\ \begin{matrix}[ Math . 4 ] & \\ {\sum }_{f = 1}^{F} {\sum }_{t = 1}^{T} log p ( {x}_{tf} \vert θ ) & ( 3 )\end{matrix}$$

Here, θ is a parameter to be optimized (estimation target), and is expressed as follows.

$$\\ \begin{matrix}[ Math . 5 ] & \\ θ = {\{ {\{ {\{ {s}_{ntf} \}}_{t = 1}^{T} , {A}_{nf} \}}_{n = 1}^{N} \}}_{f = 1}^{F} & ( 4 )\end{matrix}$$

Since each of the sound source components c_{ntf} in the model indicated in (1) is independent from each other, each observation signal vector x_{tf} follows the following multivariate Gaussian distribution with an average vector of zero and a covariance matrix of X_{tf}.

$$\\ \begin{matrix}[ Math . 6 ] & \\ p ( {x}_{tf} \vert θ ) = 𝒩 ( {x}_{tf} \vert 0 , {X}_{tf} ) & \end{matrix}$$

### Here,

$$\\ \begin{matrix}[ Math . 7 ] & \\ {X}_{tf} = {\sum }_{n = 1}^{N} {C}_{ntf} & ( 5 )\end{matrix}$$

is defined.

### <<EM Algorithm>

The objective function indicated in (3) can be maximized (locally) by an EM algorithm. Note that, for details of the EM algorithm, refer to, Reference Literature 1 and the like.

In E-Step, a conditional probability p (c_{ntf}|x_{tf}, θ) that follows the multivariate Gaussian distribution having the following average vector μ_{ntf}^{(c)} and covariance matrix Σ_{ntf}^{(c)} is calculated.

$$\\ \begin{matrix}[ Math . 8 ] & \\ {μ}_{ntf}^{{}_{} ( c )} = {C}_{ntf} {X}_{tf}^{{}_{} - 1} {x}_{tf} , {\sum }_{ntf}^{( c )} = {C}_{ntf} - {C}_{ntf} {X}_{tf}^{{}_{} - 1} {C}_{ntf} & ( 6 )\end{matrix}$$

In M-Step, the parameter θ is updated by the following expressions.

$$\begin{matrix}[ Math . 9 ] & \\ {A}_{n f} ← \frac{1}{T} {{\sum }_{t = 1}}^{T} \frac{1}{{s}_{n t f}} {\tilde{C}}_{n t f} , & ( 7 )\end{matrix}$$

$${s}_{n t f} ← \frac{1}{M} tr ( {A}_{nf}^{- 1} {\tilde{C}}_{ntf} ) , \qquad ( 8 )$$

Here, tr is an operator for obtaining a trace (that is, the sum of the diagonal components) of a matrix. Further,

$$\begin{matrix}[ Math . 10 ] & \\ {\tilde{C}}_{n t f} = 𝔼 [ {c}_{ntf} {c}_{ntf}^{H} \vert {x}_{t f} , θ ] = {μ}_{n t f}^{( c )} {μ}_{ntf}^{( c ) H} + {Σ}_{ntf}^{( c )} & ( 9 )\end{matrix}$$

is defined (that is, it is an expected value of the outer product of the sound source component c_{ntf} under an observation vector x_{tf} and the parameter θ obtained). Note that H represents conjugate transposition.

Hereinafter, in the text of the specification, an accent of an accented character such as the left side of (9) is written immediately before the left side. For example, in the text of the specification, the left side of (9) is expressed as “˜C_{ntf}”. In addition, in the text of the specification, in a case where a calligraphic character (handwritten character) such as the right side of Math. 2 or Math. 6 is confused with a normal character, scr is described immediately before the character. For example, in the text of the specification, since the calligraphic character of N is confused with the number of sound sources N, the calligraphic character N on the right side of Math. 2 is denoted as “scrN”.

### <FCAd>

Hereinafter, FCAd which is one of conventional methods will be described. Note that, for details of the FCAd, refer to Non Patent Literature 2 and the like.

In order to consider reverberation in a space such as a room, the model (FCA model) indicated in (1) is extended as follows.

$$\begin{matrix}[ Math . 11 ] & \\ {x}_{tf} = {\sum }_{n = 1}^{N} ( {c}_{n t f} + {\sum }_{l ∈ ℒ} {c}_{n t f}^{( l )} ) & ( 10 )\end{matrix}$$

### Here,

$$ℒ = \{ {l}_{1} , … , {l}_{L} \} \qquad [ Math . 12 ]$$

is defined, and it is a set having a time delay as an element. Hereinafter, this set is also referred to as a time delay set.

The sound source component c_{ntf}^{(l)} indicates that the signal output from the sound source n in the time frame t−1 is observed in the time frame t with a time delay l. It is assumed that each of these sound source components c_{ntf}^{(l)} follows the following multivariate Gaussian distribution with an average vector of zero and a covariance matrix of C_{ntf}^{(l)}.

$$\begin{matrix}[ Math . 13 ] & \\ p ( {c}_{ntf}^{( l )} \vert 0 , {C}_{ntf}^{( l )} ) , {C}_{ntf}^{( l )} = {s}_{n ( t - l ) f} {A}_{nf}^{( l )} , & ( 11 )\end{matrix}$$

Here, A_{nf}^{(l)} is a spatial correlation matrix of the sound source n that affects the M sensors by the time delay l.

According to the model (FCAd model) indicated in (10), each observation signal vector x_{tf} follows the following multivariate Gaussian distribution with an average vector of zero and a covariance matrix of X_{tf}.

$$p ( {x}_{tf} \vert θ ) = 𝒩 ( {x}_{tf} \vert 0 , {X}_{t f} ) \qquad [ Math . 14 ]$$

### Here,

$$\begin{matrix}[ Math . 15 ] & \\ {X}_{t f} = {\sum }_{n = 1}^{N} ( {C}_{n t f} + {\sum }_{l ∈ ℒ} {C}_{n t f}^{( t )} ) , & ( 12 )\end{matrix}$$

is defined. Note that C_{ntf} is defined by (2) and C_{ntf}^{(l)} is defined by (11).
<Proposed Technique (mfFCA)>

Hereinafter, the method proposed in the present embodiment will be described. In the present embodiment, a technique called multi-frame FCA (hereinafter referred to as mfFCA), which is a new extension of FCA, is proposed. The mfFCA is a method in which a correlation (for example, the correlation between the sound source component c_{ntf} and c_{n(t+1)f}^{(l)}) between sound source components generated from the power s_{ntf} of the same sound source n and observed in different time frames is considered. Thus, reverberation over a plurality of time frames can be modeled, and separation performance can be improved.

Since the following description is independent for each frequency bin f, a suffix f representing the frequency bin is omitted in the following description for the sake of simplicity.

### <<Sound Source Component Across Plurality of Time Frames>>

Let us consider the following long sound source component vector obtained by combining each sound source component (sound source component having no time delay and sound source component having a time delay) generated from the power sₙₜ of the sound source n in the time frame t.

$$\begin{matrix}[ Math . 16 ] & \\ {\overline{c}}_{n t} = {[ {c}_{nt}^{⊤} , {c}_{n ( t + {l}_{1} )}^{( {l}_{1} ) ⊤} , … , {c}_{n ( t + {l}_{L} )}^{( {l}_{L} ) ⊤} ]}^{T} ∈ {ℂ}^{M ( L + 1 )} & ( 13 )\end{matrix}$$

That is, a vector obtained by combining a sound source component having a time delay with a sound source component having no time delay is set as a sound source component vector.

Then, it is assumed that the above-described sound source component vector ⁻cₙₜ follows the following multivariate Gaussian distribution with an average vector of zero and a covariance matrix of ^{-c}ₙₜ.

$$\begin{matrix}[ Math . 17 ] & \\ p ( {\overline{c}}_{n t} ) = 𝒩 ( {\overline{c}}_{n t} \vert 0 , {\overline{C}}_{n t} ) & ( 14 )\end{matrix}$$

### Here,

$${\overline{C}}_{n t} = {s}_{n t} {\overline{A}}_{n} \qquad [ Math . 18 ]$$

is defined. Further,

$$\begin{matrix}[ Math . 19 ] & \\ {A}_{n} = [ \begin{matrix}{A}_{n}^{( 0 )} & … & {A}_{n}^{( 0 , {l}_{L} )} \\ ⋮ & ⋱ & ⋮ \\ {A}_{n}^{( {l}_{L} , 0 )} & … & {A}_{n}^{( {l}_{L} )}\end{matrix} ] & ( 15 )\end{matrix}$$

is an M(L+1)×M(L+1) matrix, and is a spatial correlation matrix representing the transmission characteristic (invariant to the time frame t) from the sound source n to the M sensors, considering all time delays.

In addition, the parameter to be optimized is as follows.

$$\begin{matrix}[ Math . 20 ] & \\ θ = \{ {\{ {\{ {s}_{n t} \}}_{i = 1}^{T} , {\overline{A}}_{n} \}}_{n = 1}^{N} \} & ( 16 )\end{matrix}$$

Here, when Aₙ⁽⁰)=Aₙ, diagonal components of (15),

$${A}_{n}^{( 0 )} , … , {A}_{n}^{( {l}_{L} 〉} \qquad [ Math . 21 ]$$

are similar to (2) and (11). On the other hand, the non-diagonal component of (15) is a matrix Aₙ^{(l,l′)} that satisfies the following expression.

$${( {A}_{n}^{( l , {l}^{′} )} )}^{H} = {A}_{n}^{( {l}^{′} , l )} \qquad [ Math . 22 ]$$

The above matrix Aₙ^{(l,l′)} represents the correlation of two sound source components cₙ₍₊ₗ₎^{(l)} and c_{n(t+l′)}^{(l″)}, which originate from the power s_{ntf} of the source n in the time frame t and are observed in different time frames. As described above, unlike the conventional methods such as FCA and FCAd, mfFCA is a spatial correlation matrix having a matrix representing a correlation between two sound source components generated from the same time frame and the same sound source and observed in different time frames as non-diagonal components. That is, it can be said that this spatial correlation matrix is a covariance matrix represented by a transmission characteristic from each sound source to each sensor including a transmission characteristic between time frames. As will be described later, the parameter is optimized by the EM algorithm on the basis of the spatial correlation matrix.

### <<Probability Model>>

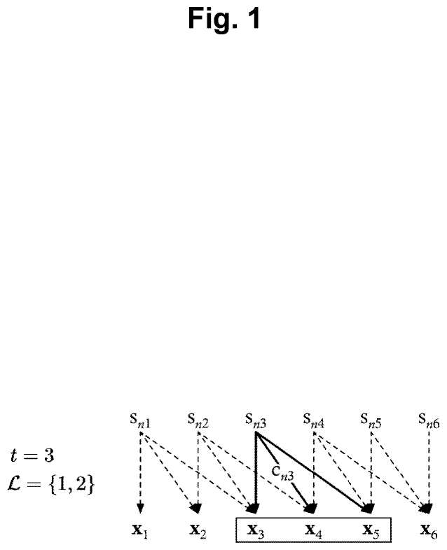

The probability model necessary for considering (13) is constructed. First, which observation signal vector the sound source component vector ^{-c}ₙₜ affects is considered. Since scrL={l₁, . . . , l_{L}}, it can be seen that the sound source component vector ⁻cₙₜ affects the time frames t and t+l₁, . . . , t+l_{L}. As an example, FIG. 1 illustrates an example of a case where t=3 and scrL={1, 2}. The example illustrated in FIG. 1 illustrates a state in which the sound source component vector ^{-c}ₙ₃ affects the observation signal vectors x₃, x₄, and x₅.

Accordingly, the following long observation signal vector is defined.

$$\begin{matrix}[ Math . 23 ] & \\ {\overline{x}}_{t} = {[ {x}_{t}^{⊤} , {x}_{t + {l}_{1}}^{⊤} , … , {x}_{t + {l}_{L}}^{⊤} ]}^{⊤} ∈ {ℂ}^{M ( L + 1 )} & ( 17 )\end{matrix}$$

Here, it is assumed that the above-described observation signal vector ⁻xₜ is independent between different time frames t. That is, it is assumed to be as follows.

$$[ Math . 24 ]$$

$$p ( {\{ {\overline{x}}_{t} \}}_{t = 1}^{T - {l}_{L}} \vert θ ) = {\prod }_{t = 1}^{T - {l}_{L}} p ( {\overline{x}}_{t} \vert θ ) \qquad ( 18 )$$

Then, it is assumed that the sound source component ⁻cₙₜ is independent between different sound sources n, and the following simultaneous probability distribution of the observation signal vector ⁻xₜ and {⁻cₙₜ|n=1, . . . , N} is considered.

$$[ Math . 25 ]$$

$$p ( {\overline{x}}_{t} , {\{ {\overline{c}}_{nt} \}}_{n = 1}^{N} \vert θ ) = p ( {\overline{x}}_{t} \vert {\{ {\overline{c}}_{nt} \}}_{n = 1}^{N} , θ ) {\prod }_{n = 1}^{N} p ( {\overline{c}}_{nt} \vert θ ) \qquad ( 19 )$$

Assuming that the subvectors constituting the long observation signal vector ⁻xₜ indicated in (17) are independent, a conditional probability distribution in a case where {⁻cₙₜ|n=1, . . . , N} is given is defined as follows.

$$[ Math . 26 ]$$

$$p ( {\overline{x}}_{t} \vert {\{ {\overline{c}}_{nt} \}}_{n = 1}^{N} , θ ) = {\prod }_{i = 0}^{L} p ( {x}_{t + {l}_{i}} \vert {\{ {\overline{c}}_{nt} \}}_{n = 1}^{N} , θ ) \qquad ( 20 )$$

At this time, when expressed as l₀=0 for simplicity, each subvector constituting the long observation signal vector ⁻xₜ follows the following multivariate Gaussian distribution.

$$[ Math . 27 ]$$

$$p ( {x}_{t + {l}_{i}} \vert {\{ {\overline{c}}_{nt} \}}_{n - 1}^{N} , θ ) = N ( {x}_{t +} {l}_{i} \vert {μ}_{t + {l}_{t}}^{( x )} , {\sum }_{t + {l}_{i}}^{( x )} ) , \qquad ( 21 )$$

$${μ}_{t + {l}_{i}}^{( x )} = {\sum }_{n = 1}^{N} {\prod }_{i} {\overline{c}}_{nt} , \qquad ( 22 )$$

$${\sum }_{t + {l}_{i}}^{( x )} = {\sum }_{n = 1}^{N} {\sum }_{j = 0 , … , i - 1 , … , L} {\prod }_{j} {\overline{C}}_{n ( t + {l}_{i} - {l}_{j} )} \qquad ( 23 )$$

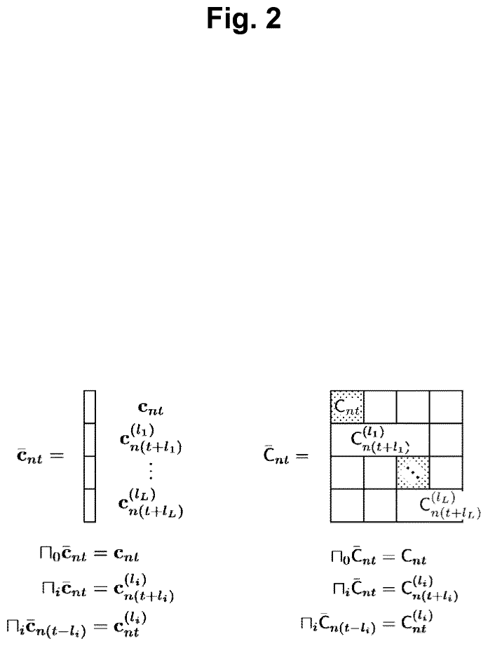

Here, Πᵢ is an operator that extracts the (i+1)th subvector when applied to a vector, and extracts the (i+1)th diagonal matrix when applied to a matrix. An example in which the Ili operator is applied to ⁻cₙₜ is illustrated in the left diagram of FIG. 2, and an example in which the Ili operator is applied to Cat is illustrated in the right diagram of FIG. 2. Therefore, the average vector indicated in (22) is defined for each subvector constituting the observation signal vector ⁻xₜ (for example, it is defined by a solid line portion in the example illustrated in FIG. 1), while the covariance matrix indicated in (23) is defined for the parameter θ (for example, it is defined by a broken line portion in the example illustrated in FIG. 1).

When the simultaneous probability distribution of the observation signal vector ⁻xₜ and {⁻cₙₜ|n=1, . . . , N} is calculated from (14) already assumed as (18) to (23) above, a simultaneous probability distribution p(⁻xₜ, {⁻cₙₜ|n=1, . . . , N}|θ) is obtained as a multivariate Gaussian distribution with an average vector of zero and a covariance matrix being as follows, details of which are omitted.

$$[ Math . 28 ]$$

$$[ \begin{matrix}{\overline{X}}_{t} & {\overline{C}}_{1 t} & {\overline{C}}_{2 t} & ⋯ & {\overline{C}}_{Nt} \\ {\overline{C}}_{1 t} & {\overline{C}}_{1 t} & 0 & ⋯ & 0 \\ {\overline{C}}_{2 t} & 0 & {\overline{C}}_{2 t} & ⋯ & 0 \\ ⋮ & ⋮ & ⋮ & ⋱ & ⋮ \\ {\overline{C}}_{Nt} & 0 & 0 & ⋯ & {\overline{C}}_{Nt}\end{matrix} ] \qquad ( 24 )$$

Here,

$$[ Math . 29 ]$$

$${\overline{X}}_{t} = [ \begin{matrix}{X}_{t} & & \\ & ⋱ & \\ & & {X}_{t + {l}_{L}}\end{matrix} ] + {\sum }_{n = 1}^{N} B offDiag {\overline{C}}_{nt} , \qquad ( 25 )$$

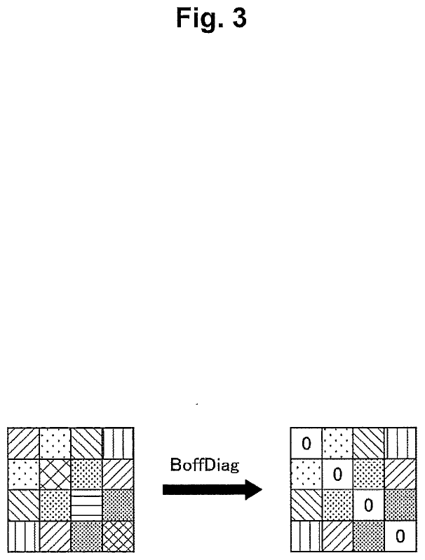

is defined. Note that Xₜ is defined in (12) (note, however, that (12) denotes the frequency bin f). BoffDiag is an operator that extracts the M×M block matrix of the non-diagonal component as it is and the M×M block matrix of the diagonal component as a zero matrix. A state of calculation of the BoffDiag operator is illustrated in FIG. 3. Note that, in the example illustrated in FIG. 3, an example of a case where L=3 is illustrated.

When the simultaneous probability distribution is obtained, a peripheral probability distribution and the conditional probability distribution can be easily obtained, and these are all multivariate Gaussian distributions (see Reference Literature 2).

The peripheral probability distribution can be obtained as a multivariate Gaussian distribution with an average vector of zero and a covariance matrix being as (25) by the following expression.

$$[ Math . 30 ]$$

$$p ( {\overline{x}}_{t} \vert θ ) = N ( {\overline{x}}_{t} \vert 0 , {\overline{X}}_{t} ) \qquad ( 26 )$$

### <<Objective Function and EM Algorithm>>

The objective function and the EM algorithm are configured using the probability model configured as described above.

In mfFCA, the objective function to be maximized is a sum of the following log likelihoods.

$$[ Math . 31 ]$$

$${\sum }_{t = 1}^{T - {l}_{L}} log p ( {\overline{x}}_{t} \vert θ ) , \qquad ( 27 )$$

The objective function indicated in (27) is maximized by the EM algorithm.

In the E-Step, a conditional probability p(^{-c}ₜ|⁻xₜ, θ) according to the following multivariate Gaussian distribution is calculated.

$$[ Math . 32 ]$$

$$p ( {\overline{c}}_{nt} \vert {\overline{x}}_{t} , θ ) = N ( {\overline{c}}_{nt} \vert {μ}_{nt}^{( \overline{c} )} , {\sum }_{nt}^{( \overline{c} )} ) , \qquad ( 28 )$$

$${μ}_{nt}^{( \overline{c} )} = {\overline{C}}_{nt} {\overline{X}}_{t}^{- 1} {\overline{x}}_{t} , \qquad ( 29 )$$

$${\sum }_{nt}^{( \overline{c} )} = {\overline{C}}_{nt} - {\overline{C}}_{nt} {\overline{X}}_{t}^{- 1} {\overline{C}}_{nt}$$

Note that, as described above, (28) and (29) can be easily obtained from the simultaneous probability distribution p(^{-x}ₜ, {⁻cₙₜ|n=1, . . . , N}|θ) (see, for example, Section 2.3.1 of Reference Literature 2 and the like).

The part of ^{-c}ₙₜ^{-x}ₜ⁻¹ in calculating the average vector indicated in (29) above is referred to as a multi-frame multi-channel Wiener filter (Reference Literature 3).

In the M-Step, the parameter θ is optimized by maximizing a function called a so-called Q function. Assuming that the parameter in the previous iteration in the EM algorithm is θ′, the Q function is defined as follows.

$$[ Math . 33 ]$$

$$Q ( θ , {θ}^{′} ) = {\sum }_{t} {𝔼}_{{\{ p ( {\overline{c}}_{nt} \vert {\overline{x}}_{t} , {θ}^{′} ) \}}_{n = 1}^{N}} log p ( {\overline{x}}_{t} , {\{ {\overline{c}}_{nt} \}}_{n = 1}^{N} \vert θ ) \qquad ( 30 )$$

$$= - {\sum }_{t = 1}^{T} {\sum }_{i = 0}^{L} \{ log det {\sum }_{t + {l}_{i}}^{( x )} + {𝔼}_{{\{ p ( {\overline{c}}_{nt} \vert {\overline{x}}_{t} , {θ}^{′} ) \}}_{n = 1}^{N}} {S}_{ti} \} \qquad ( 31 )$$

$$- {\sum }_{t = 1}^{T} {\sum }_{n = 1}^{N} \{ log det ( {s}_{nt} {\overline{A}}_{n} ) + tr [ {( {s}_{nt} {\overline{A}}_{n} )}^{- 1} {\tilde{C}}_{nt} ] \} \qquad ( 32 )$$

Here,

$$[ Math . 34 ]$$

$${S}_{ti} = tr [ {( {\sum }_{t + {l}_{i}}^{( x )} )}^{- 1} ( {x}_{t + {l}_{i}} - {μ}_{t + {l}_{i}}^{( x )} ) {( {x}_{t + {l}_{i}} - {μ}_{t + {l}_{i}}^{( x )} )}^{H} ] , \qquad ( 33 )$$

$${\tilde{C}}_{nt} = 𝔼 [ {\overline{c}}_{nt} {\overline{c}}_{nt}^{H} \vert {\overline{x}}_{t} , {θ}^{′} ] = {μ}_{nt}^{( \overline{c} )} {μ}_{nt}^{( \overline{c} ) H} + {\sum }_{nt}^{( \overline{c} )}$$

are defined.

Since it is difficult to directly maximize the Q function with respect to θ, approximation is performed such that the covariance matrix of (23) appearing in Sₜ₁ of (31) is kept fixed to the parameter θ′ before update. Thus, the following update expression is obtained.

$$[ Math . 35 ]$$

$${\overline{A}}_{n} ← \frac{1}{T} {\sum }_{t = 1}^{T} \frac{1}{{s}_{nt}} {\tilde{C}}_{nt} , \qquad ( 34 )$$

$${s}_{nt} ← \frac{1}{M ( L + 1 )} tr ( {\overline{A}}_{n}^{- 1} {\tilde{C}}_{nt} )$$

Then, after the parameter θ is optimized by the above-described EM algorithm, the target source signal (hereinafter also referred to as a separation signal) can be separated by obtaining an average vector by applying the multi-frame multi-channel Wiener filter ⁻cₙₜ^{-x}ₜ⁻¹ to the observation signal vector ⁻xₜ. Specifically, by the following expression;

$$[ Math . 36 ]$$

$${y}_{nt} = {\prod }_{0} {μ}_{nt}^{( \overline{c} )} + {\sum }_{i = 1}^{L} {\prod }_{i} {μ}_{n ( t - {l}_{i} )}^{( \overline{c} )} \qquad ( 35 )$$

the separation signal yₙₜ of the sound source n in the time frame t can be obtained.

### <Hardware Configuration of Signal Separation Device 10>

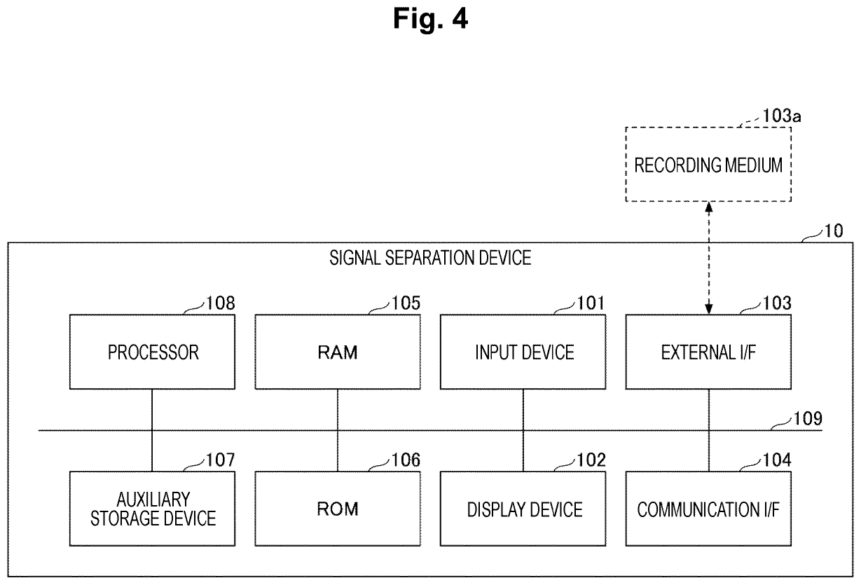

FIG. 4 illustrates a hardware configuration example of the signal separation device 10 according to the present embodiment. As illustrated in FIG. 4, the signal separation device 10 according to the present embodiment includes an input device 101, a display device 102, an external I/F 103, a communication I/F 104, a random access memory (RAM) 105, a read only memory (ROM) 106, an auxiliary storage device 107, and a processor 108. These hardware configurations are communicatively connected to each other via a bus 109.

The input device 101 is, for example, a keyboard, a mouse, a touch panel, or the like. The display device 102 is, for example, a display, a display panel, or the like. Note that the signal separation device 10 may not include, for example, at least one of the input device 101 or the display device 102.

The external I/F 103 is an interface with an external device such as a recording medium 103a. The signal separation device 10 can perform reading, writing, and the like of the recording medium 103a via the external I/F 103. Examples of the recording medium 103a include a flexible disk, a compact disc (CD), a digital versatile disk (DVD), a secure digital memory card (SD memory card), a universal serial bus (USB) memory card, and the like.

The communication I/F 104 is an interface for connecting the signal separation device 10 to a communication network. The RAM 105 is a volatile semiconductor memory (storage device) that temporarily holds programs and data. The ROM 106 is a non-volatile semiconductor memory (storage device) capable of holding programs and data even when the power is turned off. The auxiliary storage device 107 is, for example, a storage device (storage device) such as a hard disk drive (HDD) or a solid state drive (SSD). The processor 108 is, for example, an arithmetic device such as a central processing unit (CPU).

The signal separation device 10 according to the present embodiment has the hardware configuration illustrated in FIG. 4, thereby being able to implement signal separation processing to be described later. Note that the hardware configuration illustrated in FIG. 4 is an example, and the hardware configuration of the signal separation device 10 is not limited thereto. For example, the signal separation device 10 may include a plurality of auxiliary storage devices 107 and a plurality of processors 108, or may include various hardware other than the illustrated hardware.

### <Functional Configuration of Signal Separation Device 10>

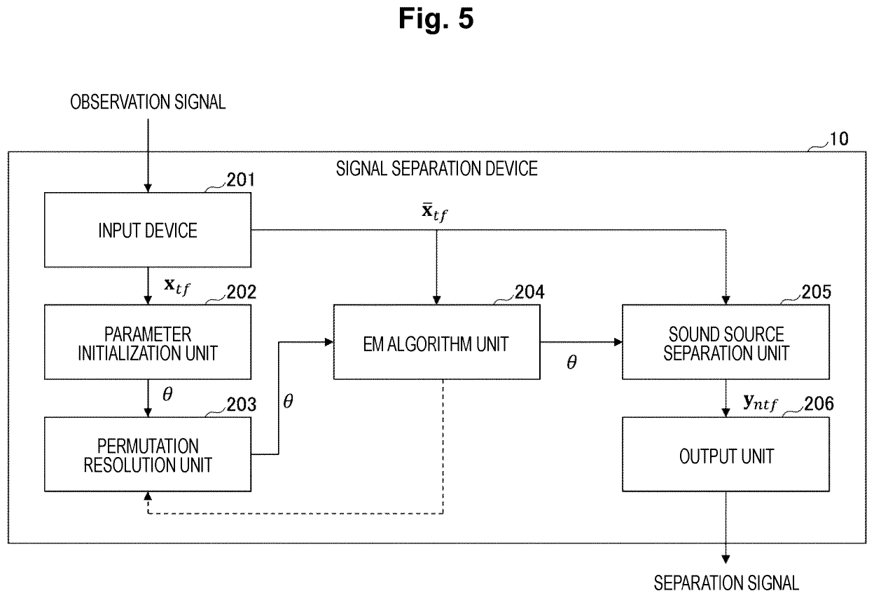

FIG. 5 illustrates a functional configuration example of the signal separation device 10 according to the present embodiment. As illustrated in FIG. 5, the signal separation device 10 according to the present embodiment includes an input unit 201, a parameter initialization unit 202, a permutation resolution unit 203, an EM algorithm unit 204, a sound source separation unit 205, and an output unit 206. These units are implemented, for example, by processing executed by the processor 108 by one or more programs installed in the signal separation device 10.

The input unit 201 receives an input of an observation signal that is a time waveform, and obtains an observation vector x_{tf} of M (where M is the number of sensors) dimensions for each time frame t and frequency bin f by applying STFT to the observation signal. In addition, the input unit 201 creates a long observation signal vector ⁻x_{tf} indicated in (17) by using a time delay set scrL={l₁, . . . , l_{L}} to be considered.

The parameter initialization unit 202 initializes a parameter θ (more precisely, a parameter obtained by extending this parameter θ to all frequency bins f) indicated in (16). Here, the parameter obtained by extending the parameter θ to all frequency bins f means a parameter expressed as {θ_{f}|f=1, . . . , F} when the frequency bin f of the parameter θ indicated in (16) is explicitly described and expressed as θ_{f}. Note that there are various initialization methods, and for example, it is sufficient if a method described in Reference Literature 4 is used. Hereinafter, a parameter obtained by extending (16) to all the frequency bins f will be described as θ again.

The permutation resolution unit 203 replaces the suffix n in the parameter θ so that the same sound source component c_{ntf} corresponds to the same suffix n in all the frequency bins f. Note that there are various methods for replacing such a suffix (that is, a permutation solving method), and for example, it is sufficient if the method described in Reference Literature 5 or the like is used.

The EM algorithm unit 204 optimizes the parameter θ by the EM algorithm. A detailed functional configuration of the EM algorithm unit 204 will be described later. Note that, in the middle of the EM algorithm by the EM algorithm unit 204, the parameter θ may be passed to the permutation resolution unit 203 to replace the suffix n (in FIG. 5, this is indicated by a broken line).

The sound source separation unit 205 obtains an average vector by applying the multi-frame multi-channel Wiener filter ^{-C}ₙₜ⁻Xₜ⁻¹ to the observation signal vector ⁻xₜ, and then obtains a separation signal y_{ntf} by (35) in order to collect sound source components with a time delay. Note that, in a case where the sound source components having a time delay (the second term on the right side of (35)) are not added, a separation signal subjected to dereverberation is obtained.

The output unit 206 obtains a separation signal having a time waveform by applying inverse short-time Fourier transform (Inverse STFT) to the separation signal y_{ntf}. Then, the output unit 206 outputs the separation signal to a predetermined arbitrary output destination.

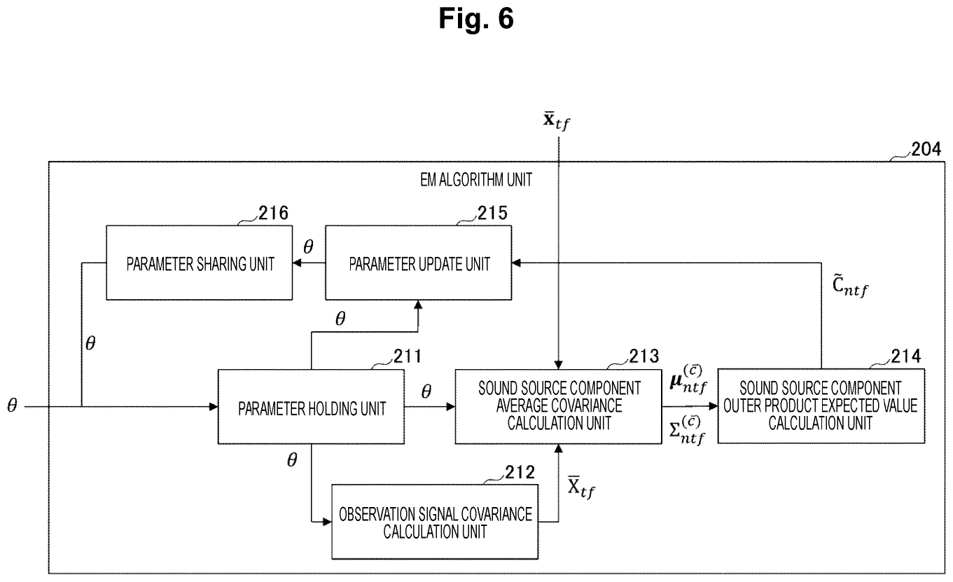

Here, a detailed functional configuration of the EM algorithm unit 204 according to the present embodiment is illustrated in FIG. 6. As illustrated in FIG. 6, the EM algorithm unit 204 according to the present embodiment includes a parameter holding unit 211, an observation signal covariance calculation unit 212, a sound source component average covariance calculation unit 213, a sound source component outer product expected value calculation unit 214, a parameter update unit 215, and a parameter sharing unit 216.

The parameter holding unit 211 receives the parameter θ and holds the parameter θ in a memory (for example, the auxiliary storage device 107 or the like).

The observation signal covariance calculation unit 212 calculates a covariance matrix ⁻X_{tf} by (25).

The sound source component average covariance calculation unit 213 calculates, by (29), the following average vector

$${μ}_{ntf}^{( \overline{c} )} \qquad [ Math . 37 ]$$

and the following covariance matrix.

$${\sum }_{ntf}^{( \overline{c} )} \qquad [ Math . 38 ]$$

The sound source component outer product expected value calculation unit 214 calculates an outer product expected value ˜C_{ntf} of a sound source component ⁻c_{ntf} by (33).

The parameter update unit 215 updates ⁻A_{nf} and s_{ntf} included in the parameter θ by (34).

The parameter sharing unit 216 shares s_{ntf} between a predetermined number (for example, four) of adjacent frequency bins determined in advance. Specifically, the parameter sharing unit 216 calculates an average of s_{ntf} of a predetermined number of adjacent frequency bins determined in advance and replaces each s_{ntf} of the frequency bins with the average. Then, the parameter sharing unit 216 rewrites s_{ntf} included in the parameter θ held in the memory by the parameter holding unit 211 to the replaced s_{ntf}.

### <Flow of Signal Separation Processing>

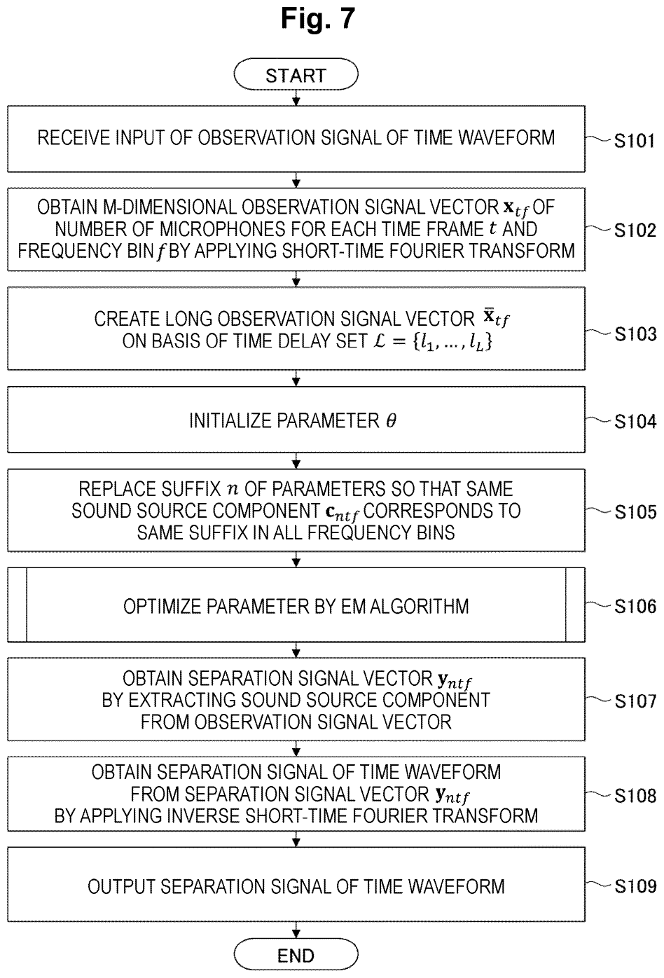

A flow of the signal separation processing according to the present embodiment will be described with reference to FIG. 7.

The input unit 201 receives an input of an observation signal that is a time waveform (step S101).

Next, the input unit 201 obtains an M-dimensional observation vector x_{tf} for each time frame t and frequency bin f by applying STFT to the observation signal input in step S101 described above (step S102).

Next, the input unit 201 creates a long observation signal vector ⁻x_{tf} indicated in (17) by using the time delay set scrL={l₁, . . . , l_{L}} to be considered (step S103).

Next, the parameter initialization unit 202 initializes a parameter θ={θ_{f}|f=1, . . . , F} obtained by extending the parameter θ_{f} indicated in (16) to all the frequency bins f (step S104).

Next, the permutation resolution unit 203 replaces the suffix n of ⁻A_{nf} and s_{ntf} included in the parameter θ so that the same sound source component c_{ntf} corresponds to the same suffix n in all the frequency bins f (step S105).

Next, the EM algorithm unit 204 optimizes the parameter θ by the EM algorithm (step S106). Note that details of this step will be described later.

Next, the sound source separation unit 205 obtains an average vector by applying the multi-frame multi-channel Wiener filter ^{-C}ₙₜ⁻Xₜ⁻¹ to the observation signal vector ⁻xₜ, and then obtains a separation signal y_{ntf} by (35) (step S107).

Next, the output unit 206 obtains a separation signal of a time waveform by applying Inverse STFT to the separation signal y_{ntf} obtained in the above step S107 (step S108).

Then, the output unit 206 outputs the separation signal obtained in step S108 described above to a predetermined arbitrary output destination (step S109). Thus, a target separation signal is obtained.

### <<Details of EM Algorithm (Step S106)>>

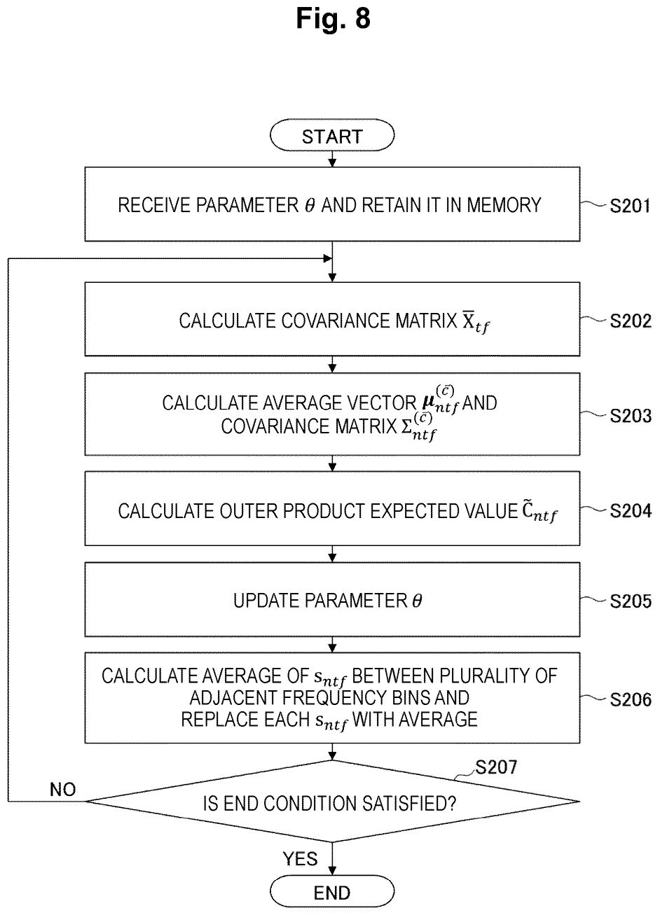

A flow of the EM algorithm according to the present embodiment will be described with reference to FIG. 8.

The parameter holding unit 211 of the EM algorithm unit 204 receives the parameter θ and holds the parameter θ in a memory (for example, the auxiliary storage device 107 or the like) (step S201).

The observation signal covariance calculation unit 212 of the EM algorithm unit 204 calculates the covariance matrix ⁻X_{tf} by (25) (step S202).

Next, the sound source component average covariance calculation unit 213 of the EM algorithm unit 204 calculates an average vector and a covariance matrix by (29) (step S203).

Next, the sound source component outer product expected value calculation unit 214 of the EM algorithm unit 204 calculates the outer product expected value ˜C_{ntf} of the sound source component ⁻c_{ntf} by (33) (step S204). Next, the parameter update unit 215 of the EM algorithm unit 204 updates ⁻A_{nf} and _{ntf} included in the parameter θ by (34) (step S205).

Next, the parameter sharing unit 216 of the EM algorithm unit 204 calculates an average of s_{ntf} of a predetermined number (for example, four) of adjacent frequency bins determined in advance, replaces each s_{ntf} of the frequency bins with the average, and rewrites the s_{ntf} held in the memory (step S206).

Then, the EM algorithm unit 204 determines whether or not a predetermined end condition is satisfied (step S207). Then, when it is determined that the end condition is satisfied, the EM algorithm unit 204 ends the EM algorithm, or otherwise returns to step S202. Here, examples of the end condition include that the number of repetitions of steps S202 to S206 reaches a predetermined number of times, an improvement amount of the sum of log likelihoods (27), which is an objective function, becomes equal to or less than a predetermined amount, or the like.

### <Experiment and Evaluation Thereof>

An experiment was performed to evaluate mfFCA.

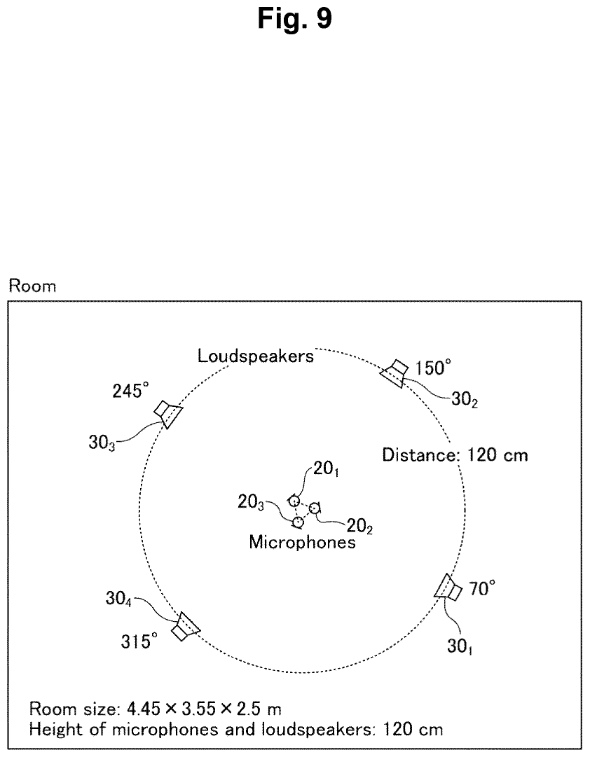

Assuming that N=4 and M=3, the experimental setting is as illustrated in FIG. 9. That is, microphones 301 to 303 were installed as sensors near the center of the room, and loudspeakers 401 to 404 were installed as sound sources at positions of 70°, 150°, 245°, and 315° on the circumference of 120 cm around the microphone. Note that the size of the room was 4.45×3.55×2.5 m, and the height of the installation positions of the microphones 301 to 303 and the loudspeakers 401 to 404 was 120 cm.

The reverberation time in the room was changed from 130 ms to 450 ms, and in each reverberation time, a mixed signal including an impulse response and sound (English) for six seconds was used as an observation signal. In addition, the sampling frequency was 8 kHz, the analysis window length of STFT was 128 ms, and the shift length was 32 ms. Therefore, T=201 and F=513.

SDRs (signal-to-distortion ratios) were used as an index for evaluating the separation performance (Reference Literature 6).

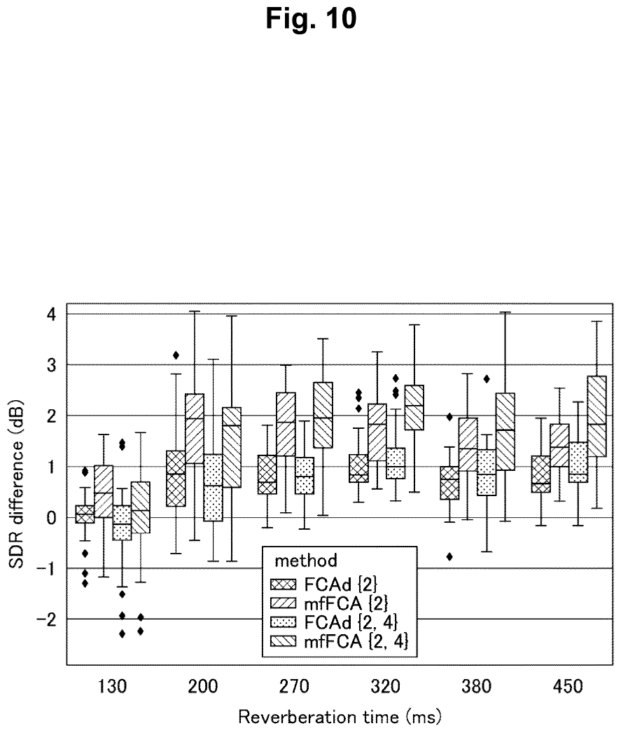

The evaluation results are illustrated in FIG. 10. In FIG. 10, “FCAd {2}” represents FCAd with scrL={2}, and “mfFCA {2}” represents mfFCA with scrL={2}. Similarly, “FCAd {2, 4}” represents FCAd with scrL={2, 4}, and “mfFCA {2, 4}” represents mfFCA with scrL={2, 4}. As illustrated in FIG. 10, when the reverberation time is other than the shortest (130 ms), it can be seen that performance improvement of approximately 2 dB on average can be achieved in mfFCA as compared with FCAd.

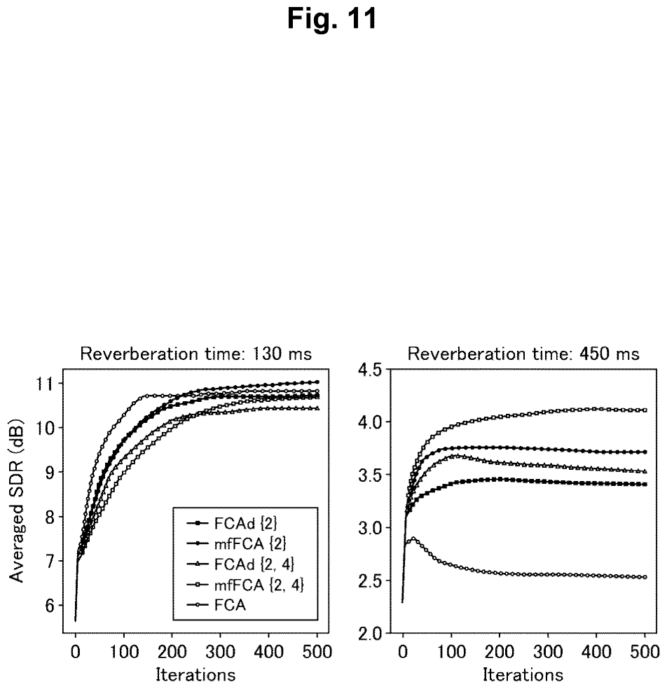

Further, FIG. 11 illustrates convergence. In the conventional methods (FCA and FCAd), particularly when the reverberation time is long, deterioration in performance is observed as the number of iterations of the algorithm for parameter update increases. On the other hand, in mfFCA, it can be seen that the performance is improved as the number of repetitions increases.

As described above, the proposed method (mfFCA) can achieve higher separation performance than the conventional methods (FCA and FCAd), and can improve the separation performance as the number of iterations of the algorithm for parameter update increases.

The present invention is not limited to the above-mentioned specifically disclosed embodiments, and various modifications and changes, combinations with known technologies, and the like can be made without departing from the scope of the claims.

### REFERENCE LITERATURE

Reference Literature 1: A. P. Dempster, N. M. Laird, and D. B. Rubin, “Maximum likelihood from incomplete data via the EM algorithm,” Journal of the Royal Statistical Society. Series B (Methodological), vol. 39, no. 1, pp. 1-22, 1977.
Reference Literature 2: C. M. Bishop, Pattern Recognition and Machine Learning, Springer, 2006.
Reference Literature 3: Z.-Q. Wang, H. Erdogan, S. Wisdom, K. Wilson, D. Raj, S. Watanabe, Z. Chen, and J. R. Hershey, “Sequential multiframe neural beamforming for speech separation and enhancement,” in 2021 IEEE Spoken Language Technology Workshop (SLT). IEEE, 2021, pp. 905-911.
Reference Literature 4: H. Sawada, R. Ikeshita, N. Ito, and T. Nakatani, “Computational acceleration and smart initialization of full-rank spatial covariance analysis,” in Proc. EUSIPCO, 2019, pp. 1-5.
Reference Literature 5: H. Sawada, S. Araki, and S. Makino, “Underdetermined convolutive blind source separation via frequency bin-wise clustering and permutation alignment,” IEEE Trans. Audio, Speech, and Language Processing, vol. 19, no. 3, pp. 516-527, March 2011.
Reference Literature 6: E. Vincent, S. Araki, F. Theis, G. Nolte, P. Bofill, H. Sawada, A. Ozerov, V. Gowreesunker, D. Lutter, and N. Q. K. Duong, “The signal separation evaluation campaign (2007-2010): Achievements and remaining challenges,” Signal Processing, vol. 92, no. 8, pp. 1928-1936-8-2012.

### REFERENCE SIGNS LIST

10 Signal separation device
101 Input device
102 Display device
103 External I/F
103a Recording medium
104 Communication I/F
105 RAM
106 ROM
107 Auxiliary storage device
108 Processor
109 Bus
201 Input unit
202 Parameter initialization unit
203 Permutation resolution unit
204 EM Algorithm unit
205 Sound source separation unit
206 Output unit
211 Parameter holding unit
212 Observation signal covariance calculation unit
213 Sound source component average covariance calculation unit
214 Sound source component outer product expected value calculation unit
215 Parameter update unit
216 Parameter sharing unit

1. A source separation apparatus comprising:
circuitry configured to
create a second observation signal vector by using (i) a first observation signal vector representing an observation signal that is obtained by mixing target signals from a plurality of signal sources and (ii) a time delay set in which a time delay until a part of the target signals is observed is used as an element, the second observation signal vector being obtained by extending the first observation signal vector in consideration of the time delay;
optimize, by using a predetermined algorithm, a parameter for
a correlation matrix representing a transmission characteristic in consideration of the time delay for the target signals, and
power of a given signal source at each time; and
separate the target signals by using an optimized parameter and the second observation signal vector.

2. The source separation apparatus according to claim 1, wherein when a time is expressed by t (1≤t≤T), a frequency is expressed by f (1≤f≤F), the given signal source is expressed as a signal source n (1<n≤N, where each of n and N is an integer), and the element of the time delay set is expressed by l (1≤l≤L),
the first observation signal vector is represented by a sum related to n of (i) a sound source component c_{ntf}⁽⁰⁾ of a target signal from each of signal sources n and (ii) sound source components c_{ntf}^{(l)}, . . . , and c_{ntf}^{(L)} of respective target signals from the signal sources n in consideration of the time delay, and
wherein the correlation matrix is a matrix with a block matrix of M×M that is defined by non-diagonal elements,
wherein M is the number of sensors that observe the observation signal,
wherein the block matrix represents a correlation between two sound source components c_{n(+l)f}^{(l)} and c_{n(t+l′)f}^{(l′)} that are observed at different times and that result from the power of the signal source n at the time t, and
wherein l≠l′, 0≤l, and l′<L.

3. The source separation apparatus according to claim 2, wherein the circuitry is configured to
calculate, with c_{ntf}=(c_{ntf}⁽⁰⁾, c_{n(t+l)f}^{(l)}, . . . , c_{n(t+L)f}^{(L)}), an average vector and a covariance matrix of a multivariate Gaussian distribution according to a conditional probability of c_{ntf} that is obtained when the second observation signal vector and the parameter are given; and
update the parameter by maximizing a sum of log likelihoods with respect to conditional probabilities of the second observation signal vector that is obtained when the parameter is given using the average vector and the covariance matrix.

4. The source separation apparatus according to claim 3, wherein the circuitry is configured to maximize the sum of the log likelihoods by maximizing a Q function that is represented by an expected value of the sum of the log likelihoods.

5. The source separation apparatus according to claim 3, wherein the circuitry is configured to update the parameter by using an expected value that is obtained by performing an outer product of c_{ntf}.

6. The source separation apparatus according to claim 3, wherein the circuitry is configured to separate the target signals by obtaining the average vector and applying a multi-frame multi-channel Wiener filter to the second observation signal vector.

7. A source separation method executed by a computer, the source separation method comprising:
creating a second observation signal vector by using (i) a first observation signal vector representing an observation signal that is obtained by mixing target signals from a plurality of signal sources and (ii) a time delay set in which a time delay until a part of the target signals is observed is used as an element, the second observation signal vector being obtained by extending the first observation signal vector in consideration of the time delay;
optimizing, by using a predetermined algorithm, a parameter for
a correlation matrix representing a transmission characteristic in consideration of the time delay for the target signals, and
power of a given signal source at each time; and
separating the target signals by using an optimized parameter and the second observation signal vector.

8. A non-transitory computer medium storage medium storing a program that causes a computer to execute the source separation method of claim 7.
